(19) United States
(12) Patent Application Publication
(10) Pub. No.: US 2023/0331165 A1
(43) Pub. Date: Oct. 19, 2023

(54) GLOVE BOX

(71) Applicant: TOYOTA JIDOSHA KABUSHIKI KAISHA, Aichi-ken (JP)

(72) Inventors: Ayaka YAMAMOTO, Nisshin-shi (JP); Keigo YOSHIDA, Nisshin-shi (JP); Masatoshi OTAKE, Nagakute-shi (JP); Kaori ABE, Toyota-shi (JP)

(21) Appl. No.: 18/172,319

(22) Filed: Feb. 22, 2023

(30) Foreign Application Priority Data
Apr. 18, 2022 (JP) 2022-068303

(51) Int. Cl. B60R 7/06

(52) U.S. Cl. CPC B60R 7/06

(57) ABSTRACT

The glove box includes a partition plate and a side wall. The partition plate is removable in a state in which the glove box is opened, and partitions the storage space of the glove box so as to divide the storage space into two parts in the vehicle front-rear direction. The side wall is provided on both sides in the vehicle width direction, and a locking portion for locking the partition plate is provided inside.

### CROSS-REFERENCE TO RELATED APPLICATION

This application claims priority to Japanese Patent Application No. 2022-068303 filed on Apr. 18, 2022, incorporated herein by reference in its entirety.

### BACKGROUND

### 1. Technical Field

The present disclosure relates to a glove box for a vehicle.

### 2. Description of Related Art

Japanese Unexamined Patent Application Publication No. 2013-169969 (JP 2013-169969 A) discloses a partition that can be used by dividing a storage space of the glove box due to arrangement of the partition into the glove box for the vehicle. The partition described in JP 2013-169969 A includes a base plate that partitions the storage space of the glove box for the vehicle such that the base plate divides the storage space into front and rear parts, a partition plate that partitions the storage space such that the partition plate divides the storage space into right and left parts, and a joint member that detachably attaches the partition plate to the base plate.

### SUMMARY

An article can be stored in an organized manner due to arrangement of the partition described in JP 2013-169969 A in the glove box, so that the storage space of the glove box can be efficiently used. However, there is room for improvement in strength of the glove box against a load applied in a front-rear direction due to collision or the like of the vehicle.

Therefore, an object of the present disclosure is to improve the strength of the glove box while enabling efficient use of the storage space of the glove box.

A glove box according to a first aspect of the present disclosure includes: a partition plate that is detachable in a state where the glove box is opened and that partitions a storage space of the glove box such that the partition plate divides the storage space into two parts in a vehicle front-rear direction; and a side wall that is provided on both sides in a vehicle width direction and that is provided with a locking portion for locking the partition plate on an inner side of the side wall.

According to such a configuration, it is possible to improve the strength against the load applied to push the glove box in the front-rear direction while enabling efficient use of the storage space of the glove box due to attachment of the partition plate

In the glove box according to the first aspect of the present disclosure, an uneven shape may be provided on at least one of a front surface of the partition plate in the vehicle front-rear direction and a rear surface of the partition plate in the vehicle front-rear direction. A recess of the uneven shape may have a shape having a small area in which a human finger does not enter.

After the partition plate is molded, the partition plate is released from the die by pressing the recess with a pressing member such as a pressing pin. As a result, a pressing hole caused by being pressed by the pressing member is provided in the recess. According to the above-described configuration, since the pressing hole is provided in the recess having a small area in which the human finger does not enter, it is possible to suppress an occupant of the vehicle from touching the pressing hole with the finger.

In the glove box according to the first aspect of the present disclosure, the uneven shape may be provided on the rear surface of the partition plate.

In the glove box according to the first aspect of the present disclosure, the uneven shape may have a geometric pattern.

According to the present disclosure, it is possible to improve the strength of the glove box while enabling efficient use of the storage space of the glove box.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a perspective view of an embodiment of the present disclosure with a glove box open; and

FIG. 2 is a diagram showing the uneven shape of the partition plate.

### DETAILED DESCRIPTION OF EMBODIMENTS

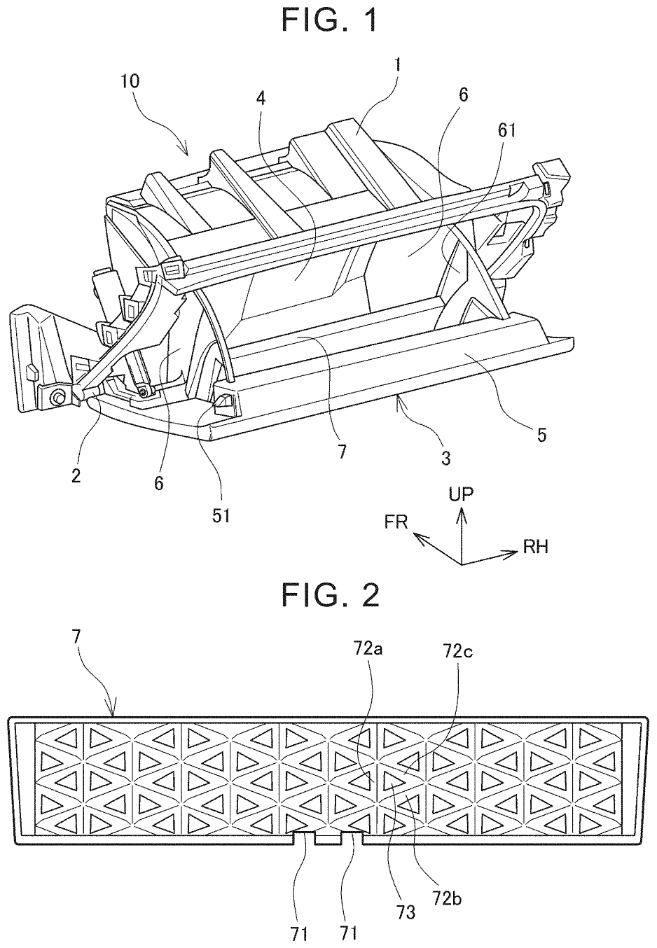

Hereinafter, the glove box 10 for a vehicle according to the present embodiment will be described with reference to FIGS. 1 and 2. The arrow FR, the arrow UP, and the arrow RH shown in FIG. 1 respectively indicate the forward direction (traveling direction), the upward direction, and the rightward direction of the vehicle. The opposite directions of the arrow FR, UP, RH indicate the vehicle-rear direction, the vehicle-lower direction, and the vehicle-left direction, respectively. Hereinafter, when the description is made simply using terms indicating directions i.e., forward and rearward, right and left, and upward and downward, these means forward and rearward in the vehicle front-rear direction, right and left in the vehicle right-left direction (vehicle width direction), and upward and downward in the vehicle up-down direction unless otherwise specified.

The glove box 10 is a small container provided in an instrument panel of a vehicle, and is disposed in front of a passenger seat. FIG. 1 is a perspective view of a glove box 10 in an open state. As shown in FIG. 1, the glove box 10 includes a fixed portion 1 fixed to an instrument panel (not shown), and a movable portion 3 rotatably attached to the fixed portion 1 with the hinge 2 as a rotation center. The movable portion 3 includes a front wall 4 provided on the front side in the vehicle front-rear direction, a rear wall 5 provided on the rear side in the vehicle front-rear direction, and side walls 6 provided on both sides in the vehicle width direction. The inside of the movable portion 3 is used as a storage space for the glove box 10. That is, the article can be stored inside the movable portion 3.

Projections 51 protruding outward in the vehicle width direction are provided on both left and right sides of the rear wall 5. When the movable portion 3 is rotated forward to close the glove box 10, the protrusion 51 engages with the fixed portion 1, so that the glove box 10 is maintained in a closed state. Then, in a state where the glove box 10 is closed, the occupant of the vehicle operates a switch (not shown) provided on the surface of the rear wall 5 on the front passenger seat side, whereby the engagement between the protrusion 51 and the fixed portion 1 is released, so that the occupant can open the glove box by rotating the movable portion 3 so as to tilt backward.

The glove box 10 comprises a removable partition plate 7. By attaching the partition plate 7 to the movable portion 3, the storage space of the glove box 10 is partitioned so as to be divided back and forth by two. Inside the side walls 6 on both left and right sides, as a locking portion for locking the partition plate 7, a groove 61 extending in the vertical direction rearward from the central portion in the front-rear direction is provided. The partition plate 7 can be attached to the movable portion 3 by inserting the left and right ends into the groove 61 and sliding downward with the glove box 10 open. Then, the partition plate 7 can be removed from the movable portion 3 by sliding upward along the groove 61 with the glove box 10 open.

Since the glove box 10 can store articles in front of and behind the partition plate 7 by attaching the partition plate 7, the storage space of the glove box 10 can be efficiently used. By attaching the partition plate 7 to the glove box 10, it is possible to prevent the articles stored in the glove box 10 from moving back and forth at the time of starting the vehicle or at the time of acceleration/deceleration, and to reduce abnormal noise caused by the movement of the articles. Further, the glove box 10, by attaching the partition plate 7, the strength against the load applied so as to push the glove box 10 in the front-rear direction is improved, it is possible to suppress the deformation collapsed in the front-rear direction.

FIG. 2 is a diagram illustrating an uneven shape of a surface of the partition plate 7. In the partition plate 7 shown in FIG. 1, description of the uneven shape of the surface is omitted. As shown in FIG. 2, the partition plate 7 is a plate having a substantially rectangular shape. Two notches 71 are formed in the vicinity of the central portion of the long side which is the lower side when the partition plate 7 is attached to the movable portion 3. When the partition plate 7 is attached to the movable portion 3 and the front surface which is the front side in the vehicle front-rear direction is the front surface and the rear surface is the rear surface, the front surface and the rear surface of the partition plate 7, the uneven shape of the geometric pattern is formed. This uneven shape includes a plurality of ridge 72a extending vertically in FIG. 2, a plurality of ridge 72b extending obliquely from the lower left to the upper right and intersecting the ridge 72a, a plurality of ridge 72c extending obliquely from the upper left to the lower right and intersecting the ridge 72a, and a plurality of recesses 73 having a substantially equilateral triangular shape. The recess 73 is surrounded by the ridge 72a, the ridge 72b, and the ridge 72c, and has a smaller area than that of a human finger.

By providing the uneven shape on the front surface and the rear surface of the partition plate 7 in this manner, the design is improved and the appearance is improved, and the effect of non-slip of the article placed in the glove box 10 is also generated. Further, by providing the uneven shape on the front surface and the rear surface of the partition plate 7, as compared with the case where the front surface and the rear surface is a flat surface without providing the uneven shape, there is also an effect that the molding failure such as sink is hardly conspicuous. The uneven shape may be provided on only one of the front surface and the rear surface. However, in a state in which the partition plate 7 is attached to the movable portion 3, since the front surface of the partition plate 7 is not visible from the occupant and the rear surface is visible, in order to improve the appearance, it is necessary to provide an uneven shape on the rear surface.

The partition plate 7 is manufactured by a method in which a material is poured into a mold and molded, and the recess 73 is pressed and released by a pressing member such as a pressing pin after molding. Therefore, the pressing hole generated by being pressed by the pressing member is formed in the recess 73 as a molding defect. By forming the pressing hole in the recess 73 in this way, it is possible to make the pressing hole inconspicuous. Further, as described above, since the area of the recess 73 is so small that the human finger does not enter, by the pressing hole is formed in the recess 73, it is possible to prevent the occupant of the vehicle from touching the pressing hole with the finger. Therefore, even if the pressing hole has a shape that feels pain when touched by a finger, for example, a shape having a pointed portion, it is possible to prevent the occupant of the vehicle from feeling pain when touching the pressing hole with a finger.

### Supplement of Embodiment

The glove box of the present disclosure is not limited to the above-described embodiments, and can be implemented in various forms within the scope of the present disclosure. For example, the locking portion of the partition plate provided on the side wall may have a shape other than a groove as long as the partition plate can be locked so as not to move in the front-rear direction. Further, the uneven shape of the surface of the partition plate may be a pattern different from the above-described form, for example, a grid pattern in which the vertically extending ridges and the horizontally extending ridges intersect at right angles.

What is claimed is:

1. A glove box comprising:
a partition plate that is detachable in a state where the glove box is opened and that partitions a storage space of the glove box such that the partition plate divides the storage space into two parts in a vehicle front-rear direction; and
a side wall that is provided on both sides in a vehicle width direction and that is provided with a locking portion for locking the partition plate on an inner side of the side wall.

2. The glove box according to claim 1, wherein:
an uneven shape is provided on at least one of a front surface of the partition plate in the vehicle front-rear direction and a rear surface of the partition plate in the vehicle front-rear direction; and
a recess of the uneven shape has a shape having a small area in which a human finger does not enter.

3. The glove box according to claim 2, wherein the uneven shape is provided on the rear surface of the partition plate.

4. The glove box according to claim 2, wherein the uneven shape has a geometric pattern.
